(19) United States
(12) Patent Application Publication
(10) Pub. No.: US 2017/0168274 A1
(43) Pub. Date: Jun. 15, 2017

(54) PROJECTION ZOOM LENS AND PROJECTION DISPLAY APPARATUS

(71) Applicant: FUJIFILM Corporation, Tokyo (JP)

(72) Inventor: Kazuki INOUE, Saitama-shi (JP)

(73) Assignee: FUJIFILM Corporation, Tokyo (JP)

(21) Appl. No.: 15/342,246

(22) Filed: Nov. 3, 2016

(30) Foreign Application Priority Data
Dec. 11, 2015 (JP) 2015-241823

(51) Int. Cl. G02B 15/177; H04N 9/31; G02B 27/00; G02B 13/04; G02B 13/16; G02B 13/18

(52) U.S. Cl. CPC G02B 15/177; G02B 13/16; G02B 13/18; G02B 27/0025; G02B 13/04; H04N 9/3197

(57) ABSTRACT

The present invention provides a projection zoom lens and a projection display apparatus including the projection zoom lens. The projection zoom lens substantially has a negative first lens group, a positive second lens group, a positive third lens group, a positive fourth lens group, and a positive fifth lens group in order from a magnification side. During magnification change, the first lens group and the fifth lens group are fixed, and the second lens group, the third lens group, and the fourth lens group are moved while changing a mutual distance in an optical axis direction. The fourth lens group includes two sets of negative-positive cemented lenses formed by cementing one negative lens and one positive lens in order from the magnification side. A predetermined conditional expression relating to the most magnification side of the fourth lens group and the negative-positive cemented lens of the most reduction side is satisfied.

### CROSS-REFERENCE TO RELATED APPLICATIONS

The present application claims priority under 35 U.S.C. §119 to Japanese Patent Application No. 2015-241823, filed on Dec. 11, 2015. Each of the above application(s) is hereby expressly incorporated by reference, in its entirety, into the present application.

### BACKGROUND OF THE INVENTION

1. Field of the Invention

The present invention relates to a projection zoom lens and a projection display apparatus, and in particular, to a projection zoom lens suitable for magnifying and projecting an original image formed, for example, by a light valve onto a screen, and a projection display apparatus having the same mounted therein.

2. Description of the Related Art

Hitherto, projection display apparatuses which magnify and project images displayed on light valves, such as a liquid crystal display element or a digital micro-mirror device (DMD: Registered Trademark) display element, onto a screen or the like have been become widespread. In particular, a projection display apparatus in which three light valves are used corresponding to illumination light components of three colors of red, green, and blue to modulate the respective illumination light components, the light components modulated by the respective light valves are combined by a color combination prism or the like, and an image is projected onto a screen through a projection lens is widely used.

Since a distance from a projection display apparatus to a screen or a screen size varies according to an installation environment, there is a tendency that a zoom lens system having a variable magnification function is preferred as a projection lens for use in a projection display apparatus such that the size of a projected image is adjustable according to the screen size. Examples of a projection zoom lens hitherto known are projection zoom lenses described in JP2014-153369A, JP5560624B, and JP2007-248840A described below. JP2014-153369A, JP5560624B, and JP2007-248840A describe a lens system which has five lens groups including a first lens group to a fifth lens group in order from a magnification side, and during magnification change, the first lens group and the fifth lens group are fixed and the second lens group to the fourth lens group are moved.

### SUMMARY OF THE INVENTION

On the other hand, in recent years, with the progress in having high precision in the light valve, there has been a need for enhancing aberration correction corresponding to the light valve in the projection lens, and in particular, there is a need for achieving high performance with satisfactorily corrected chromatic aberration. In recent years, with an increase in situations of projecting onto a large screen in a large hall, an exhibition or the like using a projection display apparatus, or situations where a larger projection screen size is required with a shorter projection distance, there is a growing demand for achieving a wide angle. In addition, there is also a need for a lens system having a small F-number.

However, in the lens system described in JP2014-153369A and JP5560624B, it is preferable that chromatic aberration is more satisfactorily corrected in a case where a high-definition light valve developed in recent years is assumed. In the lens system described in JP2007-248840A, an angle of view is insufficient, and it cannot be said that the F-number is sufficiently small.

The invention has been accomplished in consideration of the above-described situation, and an object of the invention is to provide a projection zoom lens which has a wide angle, a small F-number, satisfactorily corrected chromatic aberration and high optical performance, and a projection display apparatus including such a projection zoom lens.

A projection zoom lens of the invention comprises, in order from a magnification side, a first lens group having negative refractive power, a second lens group having positive refractive power, a third lens group having positive refractive power, a fourth lens group having positive refractive power, and a fifth lens group having positive refractive power. During magnification change, the first lens group and the fifth lens group are fixed and the second lens group, the third lens group, and the fourth lens group are moved while changing a distance from an adjacent lens group in an optical axis direction, the fourth lens group includes two sets of negative-positive cemented lenses formed by cementing one negative lens and one positive lens in order from the magnification side, and the following conditional expressions (1) and (2) are satisfied;

17<ν1p−ν1n<50 (1)

30<ν2p−ν2n<50 (2)
where
ν1p: an Abbe number for d-line of the positive lens in the negative-positive cemented lens on the most magnification side of the fourth lens group
ν1n: an Abbe number for d-line of the negative lens in the negative-positive cemented lens on the most magnification side of the fourth lens group
ν2p: an Abbe number for d-line of the positive lens in the negative-positive cemented lens on the most reduction side of the fourth lens group
ν2n: an Abbe number for d-line of the negative lens in the negative-positive cemented lens on the most reduction side of the fourth lens group.

In the projection zoom lens of the invention, it is preferable that concave surfaces of the two sets of negative-positive cemented lenses of the fourth lens group are respectively directed toward the magnification side.

In the projection zoom lens of the invention, it is preferable that the two sets of negative-positive cemented lenses of the fourth lens group are respectively formed by cementing a biconcave lens and a biconvex lens in order from the magnification side.

In the projection zoom lens of the invention, it is preferable that one of the following conditional expressions (3) to (8), (1-1), (1-2), and (2-1) to (8-1) or an arbitrary combination thereof is satisfied;

−1<fw/f1<−0.7 (3)

0.2<fw/f2<0.6 (4)

−0.65<f1/f2<−0.3 (5)

νmax<78 (6)

7<f4/RC41<10 (7)

1.5<f4/RC42<5 (8)

18<ν1p−ν1n<50 (1-1)

21<ν1p−ν1n<40 (1-2)

35<ν2p−ν2n<45 (2-1)

−0.9<fw/f1<−0.8 (3-1)

0.35<fw/f2<0.55 (4-1)

−0.6<f1/f2<−0.35 (5-1)

νmax<75 (6-1)

7.5<f4/RC41<9.5 (7-1)

2<f4/RC42<4.5 (8-1)
where
fw: a focal length of an entire system at a wide-angle end
f1: a focal length of the first lens group
f2: a focal length of the second lens group
νmax: a maximum value among Abbe numbers for d-line of lenses included in the entire system
f4: a focal length of the fourth lens group
RC41: a radius of curvature of a cemented surface of the negative-positive cemented lens on the most magnification side of the fourth lens group
RC42: a radius of curvature of a cemented surface of the negative-positive cemented lens on the most reduction side of the fourth lens group
ν1p: an Abbe number for d-line of the positive lens in the negative-positive cemented lens on the most magnification side of the fourth lens group
ν1n: an Abbe number for d-line of the negative lens in the negative-positive cemented lens on the most magnification side of the fourth lens group
ν2p: an Abbe number for d-line of the positive lens in the negative-positive cemented lens on the most reduction side of the fourth lens group
ν2n: an Abbe number for d-line of the negative lens in the negative-positive cemented lens on the most reduction side of the fourth lens group.

A projection display apparatus of the invention comprises a light source, a light valve on which light from the light source is incident, and the projection zoom lens of the invention described above as a projection zoom lens projecting an optical image according to light optically modulated by the light valve onto a screen.

The term “magnification side” means a projected side (screen side), and the screen side is referred to as the magnification side even in a case where reduced projection is performed for convenience. The term “reduction side” means an original image display area side (light valve side), and the light valve side is referred to as the reduction side even in a case where reduced projection is performed for convenience.

A term “substantially comprises” means that the projection zoom lens of the invention substantially includes, in addition to the five lens groups, lenses without any refractive power, optical elements, such as a diaphragm or a cover glass, other than the lenses, mechanical parts, such as a lens flange, a lens barrel, and a camera shake correction mechanism, and the like.

The “lens group” is not necessary a lens group constituted of a plurality of lenses, and also includes a lens group constituted of only one lens. The sign of the refractive power of each lens group represents the sign of the refractive power of the corresponding entire lens group. The sign of the refractive power of a lens group, the sign of the refractive power of a lens, the surface shape of the lens and the radius of curvature are considered in a paraxial area when the lens includes an aspherical surface. The sign of the radius of curvature is positive in a case where the surface shape is convex directed toward the magnification side, and is negative in a case where the surface shape is convex directed toward the reduction side. The conditional expressions relates to the d-line (wavelength of 587.6 nm, where nm represents nanometer.).

In the invention, a compound aspherical lens (a lens in which a spherical lens and an aspherical membrane applied on the spherical lens are constituted integrally and function as one aspherical lens) is not regarded as a cemented lens, and is handled as one lens.

According to the invention, in the zoom lens system having the five group configuration of negative, positive, positive, positive, and positive power arrangement in order from the magnification side, since the configuration of the fourth lens group is suitably set and predetermined conditional expressions are satisfied, it is possible to provide a projection zoom lens which has a wide angle, a small F-number, satisfactorily corrected chromatic aberration and high optical performance, and a projection display apparatus including the projection zoom lens.

### BRIEF DESCRIPTION OF THE DRAWINGS

FIG. 1 is a sectional view showing a lens configuration and optical paths of a projection zoom lens according to an embodiment of the invention.

FIG. 2 is a sectional view showing a lens configuration of a projection zoom lens of Example 1 of the invention.

FIG. 3 is a sectional view showing a lens configuration of a projection zoom lens of Example 2 of the invention.

FIG. 4 is a sectional view showing a lens configuration of a projection zoom lens of Example 3 of the invention.

FIG. 5 shows aberration diagrams of the projection zoom lens of Example 1 of the invention, and shows a spherical aberration diagram, an astigmatism diagram, a distortion diagram, and a lateral chromatic aberration diagram in order from the left.

FIG. 6 shows aberration diagrams of the projection zoom lens of Example 2 of the invention, and shows a spherical aberration diagram, an astigmatism diagram, a distortion diagram, and a lateral chromatic aberration diagram in order from the left.

FIG. 7 shows aberration diagrams of the projection zoom lens of Example 3 of the invention, and shows a spherical aberration diagram, an astigmatism diagram, a distortion diagram, and a lateral chromatic aberration diagram in order from the left.

FIG. 8 is a schematic configuration diagram of a projection display apparatus according to an embodiment of the invention.

### DESCRIPTION OF THE PREFERRED EMBODIMENTS

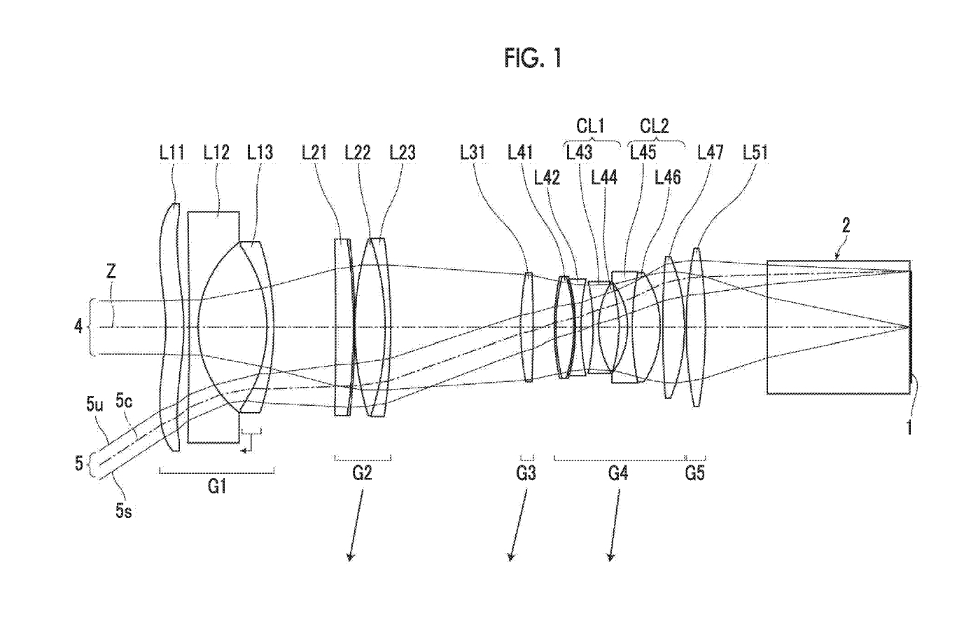

Hereinafter, an embodiment of the invention will be described in detail referring to the drawings. FIG. 1 is a sectional view showing a lens configuration at a wide-angle end of a projection zoom lens according to an embodiment of the invention and optical paths of an axial light beam 4 and a light beam 5 at a maximum angle of view, and corresponds to a projection zoom lens of Example 1 described below. In FIG. 1, the left side is a magnification side, and the right side is a reduction side.

The projection zoom lens is usable as a projection zoom lens which is mounted in, for example, a projection display apparatus and projects image information displayed on a light valve onto a screen. In FIG. 1, an optical member 2 having a parallel plane disposed on the reduction side of the projection zoom lens, and an image display surface 1 of the light valve positioned on the reduction side of the optical member 2 are shown together. For the optical member 2, a prism, various filters, a cover glass and the like are assumed. The image display surface 1 corresponds to a reduction side conjugate plane and the screen corresponds to a magnification side conjugate plane. In the projection display apparatus, light beams having image information given on the image display surface 1 are incident on the projection zoom lens through the optical member 2, and are projected onto a screen (not shown) disposed on the left side of the drawing by the projection zoom lens.

In FIG. 1, although an example where the position of the reduction side surface of the optical member 2 matches the position of the image display surface 1 is illustrated, and the invention is not necessarily limited thereto. In FIG. 1, although only one image display surface 1 is described for simplification of the drawing, the projection display apparatus may be configured such that a full color image can be displayed by separating a light beam from a light source into three primary colors by a color separation optical system and providing three light valves for the respective primary colors.

The projection zoom lens substantially has, in order from the magnification side along an optical axis Z, a first lens group G1 having negative refractive power, a second lens group G2 having positive refractive power, a third lens group G3 having positive refractive power, a fourth lens group G4 having positive refractive power, and a fifth lens group G5 having positive refractive power. With the negative, positive, positive, positive, and positive power arrangement in order from the magnification side described above, a retrofocus type configuration is obtained, and it is advantageous to achieving a wide angle and to securing a long back focus. The projection display apparatus may have a configuration in which a color combination optical system which combines modulated light from a plurality of light valves or a light beam separation optical system which separates illumination light and projection light is disposed between the lens system and the light valves, and in such a configuration, a long back focus is required.

In the projection zoom lens, during magnification changed from a wide-angle end to a telephoto end, the first lens group G1 and the fifth lens group G5 are fixed with respect to the reduction side conjugate plane, and the second lens group G2, the third lens group G3, and the fourth lens group G4 are moved while changing the distance between adjacent lens groups in an optical axis direction. In FIG. 1, arrows schematically indicating the moving directions of the respective lens groups during magnification change from the wide-angle end to the telephoto end are written below the second lens group G2, the third lens group G3, and the fourth lens group G4. In the example shown in FIG. 1, during magnification change from the wide-angle end to the telephoto end, all of the second lens group G2, the third lens group G3, and the fourth lens group G4 are moved to the magnification side without being moved backward.

The fourth lens group G4 of the projection zoom lens includes at least two sets of negative-positive cemented lenses formed by cementing one negative lens and one positive lens in order from the magnification side. With the negative-positive cemented lenses cemented in an order of negative and positive from the magnification side, it is advantageous to correction of lateral chromatic aberration of each image height on a cemented surface. The fourth lens group G4 includes a plurality of negative-positive cemented lenses, whereby it is possible to distribute a correction effect by the respective negative-positive cemented lenses and to suitably suppress chromatic aberration, and it is advantageous to suppressing longitudinal chromatic aberration and lateral chromatic aberration. The two sets of negative-positive cemented lenses among the negative-positive cemented lenses included in the fourth lens group G4 may be disposed continuously, and in such a case, it is possible to suitably suppress chromatic aberration.

For example, in the example of FIG. 1, the fourth lens group G4 has seven lenses including lenses L41 to L47 in order from the magnification side. Of these, the lens L43 and the lens L44 are cemented to constitute a first negative-positive cemented lens CL1, and the lens L45 and the lens L46 are cemented to constitute a second negative-positive cemented lens CL2.

The projection zoom lens is configured such that the following conditional expressions (1) and (2) are satisfied for the negative-positive cemented lenses of the fourth lens group G4;

17<ν1p−ν1n<50 (1)

30<ν2p−ν2n<50 (2)
where
ν1p: an Abbe number for d-line of the positive lens in the negative-positive cemented lens on the most magnification side of the fourth lens group
ν1n: an Abbe number for d-line of the negative lens in the negative-positive cemented lens on the most magnification side of the fourth lens group
ν2p: an Abbe number for d-line of the positive lens in the negative-positive cemented lens on the most reduction side of the fourth lens group
ν2n: an Abbe number for d-line of the negative lens in the negative-positive cemented lens on the most reduction side of the fourth lens group.

The material of the negative-positive cemented lens on the most magnification side of the fourth lens group G4 is selected such that the conditional expression (1) is satisfied, whereby it is possible to suitably suppress longitudinal chromatic aberration and lateral chromatic aberration. In order to increase the above-described effect relating to the conditional expression (1), it is preferable that the following conditional expression (1-1) is satisfied, and it is more preferable that the following conditional expression (1-2) is satisfied.

18<ν1p−ν1n<50 (1-1)

21<ν1p−ν1n<40 (1-2)

The material for the negative-positive cemented lens on the most reduction side of the fourth lens group G4 is selected such that the conditional expression (2) is satisfied, whereby it is possible to satisfactorily suppress longitudinal chromatic aberration and lateral chromatic aberration. In order to increase the above-described effect relating to the conditional expression (2), it is preferable that the following conditional expression (2-1) is satisfied.

35<ν2p−ν2n<45 (2-1)

In general, the smaller the F-number and the wider the angle of view, the more difficult correction of chromatic aberration becomes. The fourth lens group G4 includes at least two sets of negative-positive cemented lenses, and the conditional expressions (1) and (2) are satisfied, whereby it is advantageous to satisfactory correction of longitudinal chromatic aberration and lateral chromatic aberration and it becomes easy to realize a lens system having a small F-number and a wide angle. The fourth lens group G4 in the example of FIG. 1 includes two sets of negative-positive cemented lenses, and does not include a three-element cemented lens. In the case where such a configuration is made and the conditional expressions (1) and (2) are satisfied, it is possible to realize satisfactory correction of chromatic aberration without using a three-element cemented lens, and to achieve reduction in the size of the lens system and reduction in costs compared to a case of using a three-element cemented lens.

It is preferable that the two sets of negative-positive cemented lenses among the negative-positive cemented lenses included in the fourth lens group G4 respectively have a concave surface directed toward the magnification side. That is, it is preferable that the surface on the magnification side of each of the negative lenses in the two sets of negative-positive cemented lenses of the fourth lens group G4 is a concave surface. In such a case, it is advantageous to suppressing curvature of field. In a case where the fourth lens group G4 has three or more sets of negative-positive cemented lenses, while two sets of negative-positive cemented lenses satisfying the conditional expressions (1) and (2) may be different from or may be the same as two sets of negative-positive cemented lenses having a concave surface directed toward the magnification side, in a case where these sets are the same, it is possible to perform efficient aberration correction.

It is preferable that the two sets of negative-positive cemented lenses among the negative-positive cemented lenses included in the fourth lens group G4 are respectively formed by cementing a biconcave lens and a biconvex lens in order from the magnification side. In such a case, it becomes easy to secure a long back focus, and it is advantageous to suppressing astigmatism. In a case where the fourth lens group G4 has three or more sets of negative-positive cemented lenses, while two sets of negative-positive cemented lenses respectively satisfying the conditional expressions (1) and (2) may be different from or may be the same as two sets of negative-positive cemented lenses formed by cementing a biconcave lens and a biconvex lens in order from the magnification side, in a case where these sets are the same, it is possible to perform efficient aberration correction.

In this projection zoom lens, it is preferable that either or an arbitrary combination of the following conditional expressions (3) to (8) is satisfied;

−1<fw/f1<−0.7 (3)

0.2<fw/f2<0.6 (4)

−0.65<f1/f2<−0.3 (5)

νmax<78 (6)

7<f4/RC41<10 (7)

1.5<f4/RC42<5 (8)
where
fw: a focal length of an entire system at a wide-angle end
f1: a focal length of the first lens group
f2: a focal length of the second lens group
νmax: a maximum value among Abbe numbers for d-line of lenses included in the entire system
f4: a focal length of the fourth lens group
RC41: a radius of curvature of a cemented surface of the negative-positive cemented lens on the most magnification side of the fourth lens group
RC42: a radius of curvature of a cemented surface of the negative-positive cemented lens on the most reduction side of the fourth lens group.
Here, fw is a focal length in a case where a projection distance is 3.13 meters.

If the value of fw/f1 is set so as not to become equal to or less than a lower limit of the conditional expression (3), it is advantageous to suppressing distortion. If the value of fw/f1 is set so as not to become equal to or greater than an upper limit of the conditional expression (3), it is advantageous to securing a long back focus and to achieving a wide angle. In order to increase the effect relating to the conditional expression (3), it is preferable that the following conditional expression (3-1) is satisfied.

−0.9<fw/f1<−0.8 (3-1)

If the value of fw/f2 is set so as not to become equal to or less than a lower limit of the conditional expression (4), it is possible to suppress the amount of movement of the second lens group G2 during magnification change. It also becomes easy to suppress the amount of fluctuation of chromatic aberration during magnification change. If the value of fw/f2 is set so as not to become equal to or greater than an upper limit of the conditional expression (4), it is advantageous to suppressing astigmatism. In order to increase the effect relating to the conditional expression (4), it is preferable that the following conditional expression (4-1) is satisfied.

0.35<fw/f2<0.55 (4-1)

If the value of f1/f2 is set so as not to become equal to or less than a lower limit of the conditional expression (5), it is advantageous to suppressing lateral chromatic aberration. If the value of f1/f2 is set so as not to become equal to or greater than an upper limit of the conditional expression (5), it is advantageous to suppressing astigmatism. In order to increase the effect relating to the conditional expression (5), it is preferable that the following conditional expression (5-1) is satisfied.

−0.6<f1/f2<−0.35 (5-1)

If the value of νmax is set so as not to become equal to or greater than an upper limit of the conditional expression (6), it becomes easy to balance chromatic aberration, and it is also possible to achieve reduction in costs. In order to increase the effect relating to the conditional expression (6), it is preferable that the following conditional expression (6-1) is satisfied. It is preferable that νmax is selected within a range satisfying the following conditional expression (6-2), and if the value of νmax is set so as not to become equal to or less than a lower limit of the conditional expression (6-2), it becomes easy to suppress the amount of fluctuation of chromatic aberration during magnification change. In order to increase the effect relating to the conditional expression (6-2), it is preferable that the following conditional expression (6-3) is satisfied.

νmax<75 (6-1)

7.5<f4/RC41<9.5 (7-1)

2<f4/RC42<4.5 (8-1)

If the conditional expression (7) is satisfied, it is possible to satisfactorily suppress longitudinal chromatic aberration and lateral chromatic aberration. In order to increase the effect relating to the conditional expression (7), it is preferable that the following conditional expression (7-1) is satisfied.

7.5<f4/RC41<9.5 (7-1)

If the conditional expression (8) is satisfied, it is possible to satisfactorily suppress longitudinal chromatic aberration and lateral chromatic aberration. In order to increase the effect relating to the conditional expression (8), it is preferable that the following conditional expression (8-1) is satisfied.

2<f4/RC42<4.5 (8-1)

In this projection zoom lens, it is preferable that the reduction side is configured telecentric. If the reduction side is configured telecentric, even in a case where an optical member having incidence angle dependence is disposed between the lens system and the light valve, it is possible to prevent deterioration of performance due to the incidence angle dependence.

The state where “the reduction side is telecentric” indicates a state where, when a light beam is viewed in a direction from the magnification side to the reduction side, an angle bisector line of an outermost ray on an upper side and an outermost ray on a lower side in a cross-section of the light beam focused on an arbitrary point of the reduction side conjugate plane is nearly parallel with the optical axis Z. However, the state where the reduction side is telecentric is not limited to a case where the reduction side is completely telecentric, that is, a case where the angle bisector line is completely parallel with the optical axis Z, and this means that a case where there is a slight error is also included. Here, a case where there is a slight error is a case where the inclination of the angle bisector line with respect to the optical axis Z is within a range of −5° to +5°. However, the state where “the reduction side is telecentric” means that the inclination of a principal ray with respect to the optical axis Z is within a range of −5° to +5° in a lens system having an aperture diaphragm. The example shown in FIG. 1 is a lens system having no aperture diaphragm, and FIG. 1 illustrates an outermost ray 5u on the upper side, an outermost ray 5s on the lower side, and a ray 5c corresponding to an angle bisector line of the outermost ray 5u on the upper side and the outermost ray 5s on the lower side with respect to the light beam 5 at the maximum angle of view.

A detailed configuration of lenses of each lens group in the example of FIG. 1 will be described. The first lens group G1 has, in order from the magnification side, three lenses including lenses L11 to L13. The lens L11 has a negative meniscus shape having a concave surface directed toward the magnification side in a paraxial area. The lens L12 is a negative lens which has a concave surface directed toward the reduction side. The lens L13 is a negative lens which has a concave surface directed toward the magnification side.

The second lens group G2 has, in order from the magnification side, three lenses including lenses L21 to L23. The lens L21 is a compound aspherical lens in which an aspherical membrane is applied to the surface on the reduction side. The lens L22 is a positive lens, the lens L23 is a negative lens, and the lens L22 and the lens L23 are cemented. The third lens group G3 has only one lens, a lens L31, which is a biconvex lens.

The fourth lens group G4 has, in order from the magnification side, seven lenses including lenses L41 to L47. The lens L41 is a compound aspherical lens in which aspherical membranes are applied to the surfaces on the magnification side and the reduction side. The lens L42 is a biconcave lens. The lens L43 is a biconcave lens, the lens L44 is a biconvex lens, and the lens L43 and the lens L44 are cemented to constitute a first negative-positive cemented lens CL1. The lens L45 is a biconcave lens, the lens L46 is a biconvex lens, and the lens L45 and the lens L46 are cemented to constitute a second negative-positive cemented lens CL2. The lens L47 is a biconvex lens. The fifth lens group G5 has one lens, a lens L51, which is a biconvex lens.

In the example of FIG. 1, focusing when the projection distance is changed is performed by moving only the lens L13 along the optical axis Z. When the projection distance is changed from infinity to a finite distance, as indicated by an arrow in a horizontal direction below the lens L13 of FIG. 1, focusing is performed by moving the lens L13 from the reduction side to the magnification side. However, in the invention, the lens moving during focusing is not limited to the above-described example, and focusing may be performed by moving one or more lenses other than the lens L13 or focusing may be performed by moving the entire first lens group G1.

The preferable configurations and possible configurations described above may be combined arbitrarily, and it is preferable that the configurations are selectively employed as appropriate according to the requirements of the projection zoom lens. The configurations described above are employed as appropriate, whereby it is possible to realize an optical system capable of coping with more satisfactory optical performance or higher specification. According to this embodiment, it is possible to realize a projection zoom lens which has a wide angle, a small F-number, satisfactorily corrected chromatic aberration and high optical performance. The “wide angle” described herein means that a maximum full angle of view at the wide-angle end is equal to or greater than 60°, and the state where “the F-number is small” means that the F-number at the wide-angle end is smaller than 1.8.

Next, numerical value examples of the projection zoom lens of the invention will be described.

### Example 1

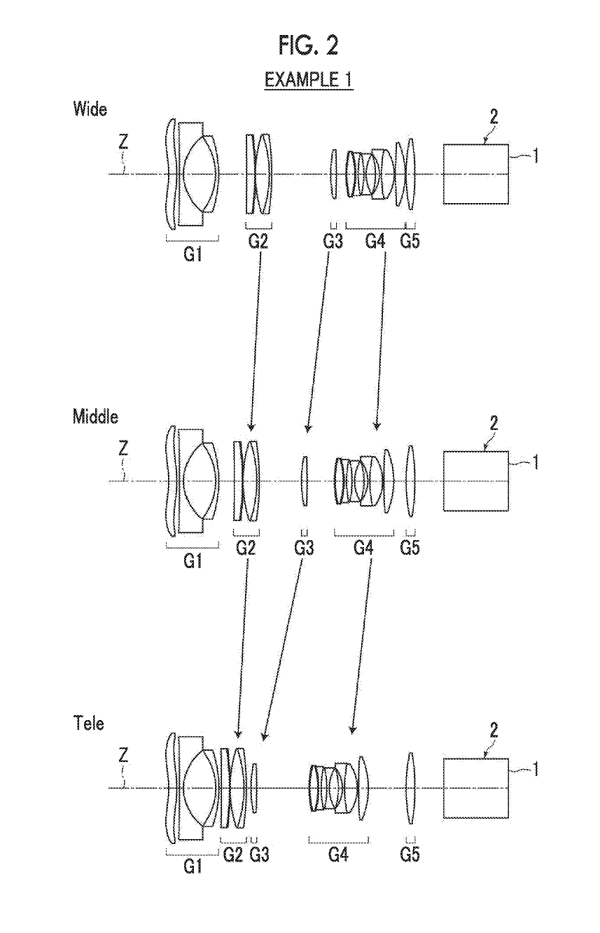

FIG. 2 is a sectional view of a projection zoom lens of Example 1. In FIG. 2, the left side is the magnification side, the right side is the reduction side, the upper side denoted as “Wide” shows a wide-angle end state, the middle side denoted as “Middle” shows a middle focal length state, and the lower side denoted as “Tele” shows a telephoto end state. Arrows indicating the schematic moving directions of the respective lens groups during magnification change from the wide-angle end state to the middle focal length state are shown between the upper side and the middle side, and arrows indicating the schematic moving directions of the respective lens groups moving during magnification change from the middle focal length state to the telephoto end state are shown between the middle side and the lower side. As a lens configuration of the projection zoom lens of Example 1 is described as above as the example shown in FIG. 1, overlapping description will be omitted herein.

Table 1 shows basic lens data of the projection zoom lens of Example 1, Table 2 shows specs and values of variable surface distances, and Table 3 shows aspherical surface coefficients. The Si column of Table 1 indicates an i-th (where i=1, 2, 3, . . . ) surface number in which a surface number is given to each surface of each component in a serially increasing manner toward the reduction side with the magnification side surface of the most magnification side component being taken as the first surface, the Ri column indicates the radius of curvature of the i-th surface, and the Di column indicates the surface distance between the i-th surface and the (i+1)th surface on the optical axis Z. The Ndj column of Table 1 indicates the refractive index of a j-th (where j=1, 2, 3, . . . ) component relating to the d-line (wavelength of 587.6 nm) in a serially increasing manner toward the reduction side with the most magnification side component being taken as the first component, and the vdj column indicates the Abbe number for d-line of the j-th component.

Here, the sign of the radius of curvature is positive in a case where the surface shape is convex directed toward the magnification side, and is negative in a case where the surface shape is convex directed toward the reduction side. Table 1 also shows the optical members 2. In Table 1, symbol DD[ ] is used for a variable surface distance changing during magnification change, and the surface number on the magnification side of the distance is given in [ ] and entered in the Di column.

Table 2 shows a zoom ratio Zr, a focal length f of the entire system, an F-number FNo., a maximum full angle of view 2ω and a value of a variable surface distance, with respect to the d-line. (°) in the 2ω column means that the unit is degree. In Table 2, the respective values of the wide-angle end state, the middle focal length state and the telephoto end state are respectively shown in the columns denoted as “Wide”, “Middle”, and “Tele”. The values of Table 1 and Table 2 are values in a case where the projection distance is 3.13 m.

In Table 1, an asterisk mark * is attached to the surface number of an aspherical surface, and a numerical value of a paraxial radius of curvature is given in the radius of curvature column of the aspherical surface. Table 3 shows the aspherical surface coefficient of each aspherical surface of Example 1. “E-n” (where n: integer) in the numerical values of the aspherical surface coefficients of Table 3 means “×10⁻ⁿ”. The aspherical surface coefficients are the values of respective coefficients KA and Am (where m=3, 4, 5, . . . , and 10, or m=4, 6, 8, and 10) in an aspherical surface expression represented by the following expression.

$$Zd = \frac{C {h}^{2}}{1 + \sqrt{1 - KA {C}^{2} {h}^{2}}} + {\sum }_{m} Am {h}^{m}$$

### Where

Zd: aspherical surface depth (length of vertical line from point on aspherical surface at height h to a plane perpendicular to optical axis in contact with aspherical surface vertex)
h: height (distance from optical axis to the lens surface)
C: paraxial curvature
KA, Am: aspherical surface coefficient.

In data of the respective tables, degree is used as the unit of angle and millimeter (mm) is used as the unit of length, but other appropriate units may also be used as optical systems are usable even when the optical systems are proportionally enlarged or proportionally reduced. In the respective tables described below, numerical values rounded at predetermined digits are described.

TABLE 1
Example 1

| Si | Ri | Di | Ndj | νdj |
|---|---|---|---|---|
| *1 | −49.9998 | 5.0009 | 1.49100 | 57.58 |
| *2 | −54.5568 | 1.5002 | | |
| 3 | −1279.6590 | 2.5006 | 1.65160 | 58.55 |
| 4 | 29.9095 | 19.2300 | | |
| 5 | −37.1690 | 1.8995 | 1.53775 | 74.70 |
| 6 | −73.6382 | DD[6] | | |
| 7 | −1385.0896 | 4.9559 | 1.95906 | 17.47 |
| 8 | −172.6827 | 0.4000 | 1.52516 | 53.74 |
| *9 | −187.1651 | 0.0000 | | |
| 10 | 81.3445 | 8.4203 | 1.83400 | 37.16 |
| 11 | −75.3701 | 1.4991 | 1.95906 | 17.47 |
| 12 | −167.1711 | DD[12] | | |
| 13 | 78.2206 | 3.4503 | 1.59522 | 67.73 |
| 14 | −349.3851 | DD[14] | | |
| *15 | 70.4812 | 0.4009 | 1.52516 | 53.74 |
| 16 | 56.9198 | 4.9905 | 1.53775 | 74.70 |
| 17 | −47.2693 | 0.3999 | 1.52516 | 53.74 |
| *18 | −48.2444 | 0.0765 | | |
| 19 | −50.8379 | 1.5006 | 1.95375 | 32.32 |
| 20 | 63.1400 | 3.4022 | | |
| 21 | −57.7090 | 1.5000 | 1.58267 | 46.42 |
| 22 | 23.7226 | 5.6513 | 1.53775 | 74.70 |
| 23 | −41.1811 | 2.4187 | | |
| 24 | −20.2751 | 1.3009 | 1.72047 | 34.71 |
| 25 | 77.6240 | 7.7770 | 1.53775 | 74.70 |
| 26 | −27.0134 | 0.7280 | | |
| 27 | 265.4593 | 5.9965 | 1.85025 | 30.05 |
| 28 | −50.2459 | DD[28] | | |
| 29 | 108.4219 | 5.4359 | 1.59522 | 67.73 |
| 30 | −131.9111 | 17.2000 | | |
| 31 | ∞ | 39.6050 | 1.51633 | 64.14 |
| 32 | ∞ | | | |

TABLE 2
Example 1

| | Wide | Middle | Tele |
|---|---|---|---|
| Zr | 1.0 | 1.2 | 1.6 |
| f | 23.97 | 28.77 | 38.38 |
| FNo. | 1.62 | 1.86 | 2.30 |
| 2ω (°) | 66.2 | 56.6 | 43.6 |
| DD[6] | 17.19 | 9.61 | 1.70 |
| DD[12] | 36.00 | 25.75 | 2.81 |
| DD[14] | 5.92 | 16.69 | 32.06 |
| DD[28] | 0.50 | 7.55 | 23.03 |

TABLE 3
Example 1

Surface Number

| | 1 | 2 |
|---|---|---|
| KA | −9.9780094E+00 | −1.1203292E+01 |
| A3 | −3.1242891E−05 | −1.9673395E−05 |
| A4 | 1.9127548E−05 | 1.5808745E−05 |
| A5 | −3.5268782E−07 | −3.0870349E−07 |
| A6 | −1.2266194E−08 | −6.7224129E−09 |
| A7 | 3.9510815E−10 | −1.9005194E−11 |
| A8 | 3.6994105E−12 | 2.6692524E−12 |
| A9 | −2.3547841E−13 | 3.7586858E−13 |
| A10 | 3.0436112E−15 | −8.0838089E−15 |

| | Surface Number | | |
|---|---|---|---|
| | 9 | 15 | 18 |
| KA | 4.5429056E+00 | −1.6316120E+01 | 6.6903415E+00 |
| A4 | 4.1192909E−07 | 9.2846570E−06 | 1.0619140E−05 |
| A6 | 6.4859694E−10 | −1.4571349E−08 | 6.2272608E−10 |
| A8 | −1.1098332E−12 | 3.2193765E−11 | −9.1361969E−11 |
| A10 | 8.1090811E−16 | −1.8478071E−13 | 3.0457203E−13 |

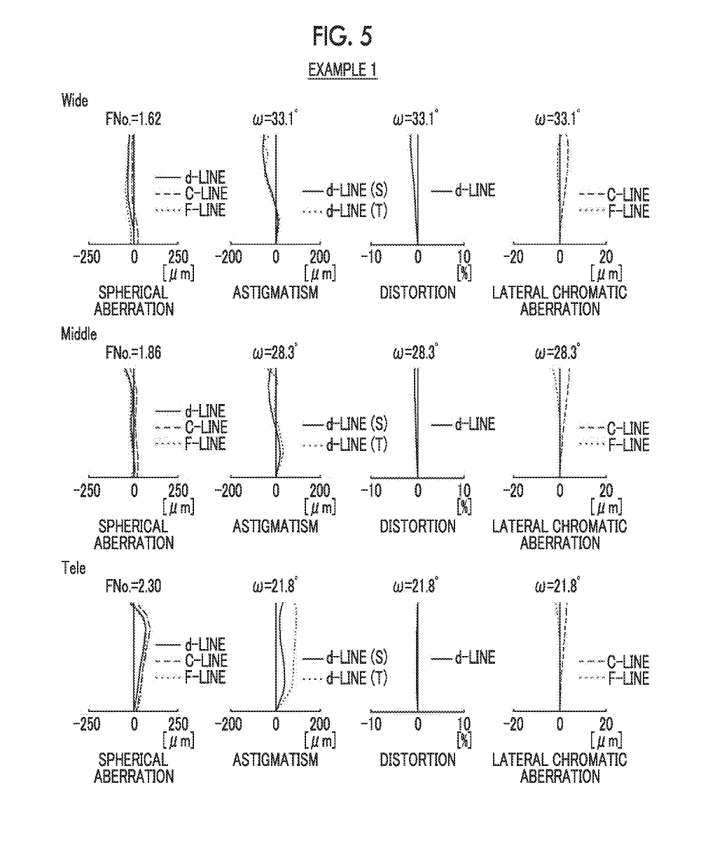

FIG. 5 shows respective aberration diagrams of spherical aberration, astigmatism, distortion, and lateral chromatic aberration of the projection zoom lens of Example 1 in order from the left in a case where the projection distance is 3.13 m. In FIG. 5, the upper side denoted as “Wide” shows a wide-angle end state, the middle side denoted as “Middle” shows a middle focal length state, and the lower side denoted as “Tele” shows a telephoto end state. Referring to FIG. 5, in the spherical aberration diagram, aberrations for d-line (wavelength of 587.6 nm), C-line (wavelength of 656.3 nm), and F-line (wavelength of 486.1 nm) are respectively indicated by a solid line, a long broken line, and a short broken line. In the astigmatism diagram, aberrations for d-line in a sagittal direction and a tangential direction are respectively indicated by a solid line and a dotted line. In the distortion diagram, an aberration for d-line is indicated by a solid line. In the lateral chromatic aberration diagram, aberrations for C-line and F-line are respectively indicated by a long broken line and a short broken line. In the spherical aberration diagram, FNo. means an F-number, and in other aberration diagrams, ω means a half angle of view.

As the signs, the meanings, and the description methods used in the description of Example 1 described above will apply to the following examples unless otherwise specifically described, overlapping description will be omitted in the following description.

### Example 2

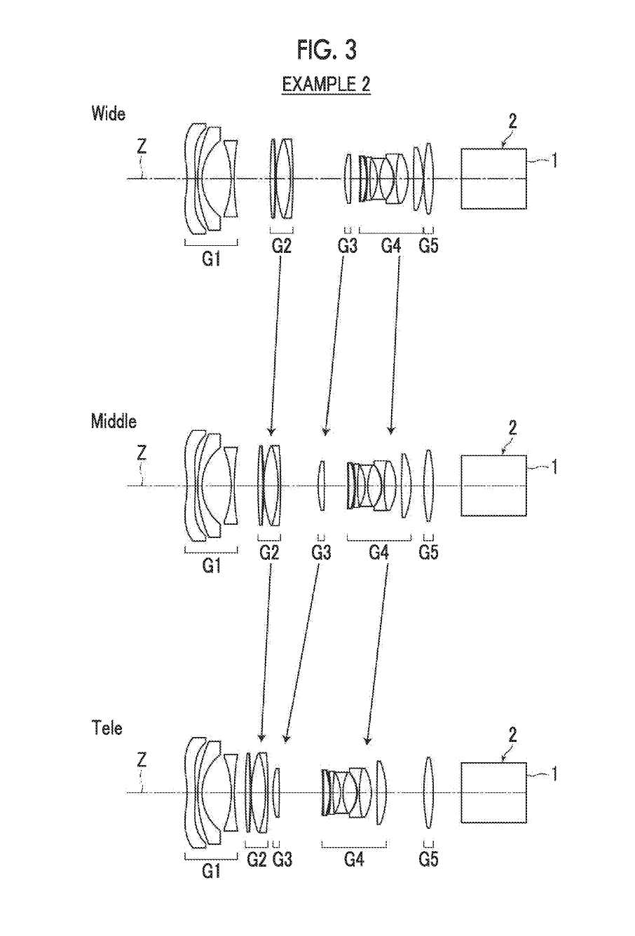

FIG. 3 is a sectional view of a projection zoom lens of Example 2. The projection zoom lens of Example 2 substantially has five lens groups including a first lens group G1 to a fifth lens group G5 in order from the magnification side. The sign of refractive power of each lens group, the lens groups moving during magnification change, the number of lenses in each lens group are the same as those in Example 1. Focusing when the projection distance is changed from infinity to a finite distance is performed by moving only the lens on the most reduction side of the first lens group G1 to the magnification side along the optical axis Z.

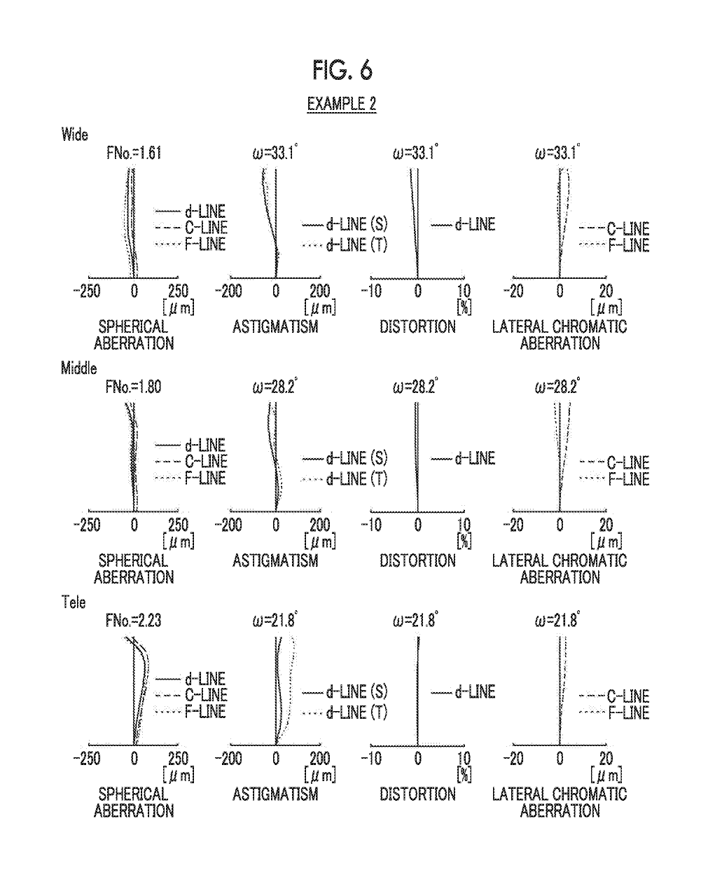

Table 4 shows basic lens data of the projection zoom lens of Example 2, Table 5 shows specs and values of variable surface distances, and Table 6 shows aspherical surface coefficients. An aspherical membrane is applied to each of the surface on the reduction side of the lens on the most magnification side of the second lens group G2 and the surfaces on the magnification side and the reduction side of the lens on the most magnification side of the fourth lens group G4, and these two lenses are compound aspherical lenses. FIG. 6 shows respective aberration diagrams of the projection zoom lens of Example 2. Data shown in Table 4, Table 5, and FIG. 6 is data in a case where the projection distance is 3.13 m.

TABLE 4
Example 2

| Si | Ri | Di | Ndj | νdj |
|---|---|---|---|---|
| *1 | −50.0002 | 5.0006 | 1.49100 | 57.58 |
| *2 | −84.3595 | 1.5007 | | |
| 3 | 77.6651 | 2.5006 | 1.65160 | 58.55 |
| 4 | 30.4070 | 17.7500 | | |
| 5 | −60.0920 | 1.8995 | 1.53775 | 74.70 |
| 6 | 143.1377 | DD[6] | | |
| 7 | 263.2694 | 2.9747 | 1.95906 | 17.47 |
| 8 | −349.7576 | 0.6000 | 1.52516 | 53.74 |
| *9 | −277.8477 | 0.0000 | | |
| 10 | 72.0324 | 8.7507 | 1.83400 | 37.16 |
| 11 | −80.7183 | 1.4992 | 1.95906 | 17.47 |
| 12 | −334.9141 | DD[12] | | |
| 13 | 61.3102 | 3.8659 | 1.59522 | 67.73 |
| 14 | −346.0364 | DD[14] | | |
| *15 | −239.4705 | 0.4009 | 1.52516 | 53.74 |
| 16 | −1150.0662 | 3.6532 | 1.53775 | 74.70 |
| 17 | −44.6065 | 0.4007 | 1.52516 | 53.74 |
| *18 | −44.5693 | 0.0006 | | |
| 19 | −99.2543 | 1.5006 | 1.95375 | 32.32 |
| 20 | 98.1817 | 4.5925 | | |
| 21 | −24.4763 | 1.5000 | 1.58267 | 46.42 |
| 22 | 28.6003 | 8.3587 | 1.53775 | 74.70 |
| 23 | −19.6822 | 0.3912 | | |
| 24 | −19.0323 | 1.3009 | 1.72047 | 34.71 |
| 25 | 72.7616 | 7.2467 | 1.53775 | 74.70 |
| 26 | −31.4661 | 3.3630 | | |
| 27 | 496.0084 | 5.7995 | 1.85025 | 30.05 |
| 28 | −53.1980 | DD[28] | | |
| 29 | 114.4905 | 5.7327 | 1.59522 | 67.73 |
| 30 | −111.6652 | 17.2000 | | |
| 31 | ∞ | 39.6050 | 1.51633 | 64.14 |
| 32 | ∞ | | | |

TABLE 5
Example 2

| | Wide | Middle | Tele |
|---|---|---|---|
| Zr | 1.0 | 1.2 | 1.6 |
| f | 23.99 | 28.80 | 38.42 |
| FNo. | 1.61 | 1.80 | 2.23 |
| 2ω (°) | 66.2 | 56.4 | 43.6 |
| DD[6] | 22.03 | 14.54 | 6.85 |
| DD[12] | 31.36 | 22.92 | 3.04 |
| DD[14] | 5.53 | 14.09 | 26.57 |
| DD[28] | 0.50 | 7.88 | 22.97 |

TABLE 6
Example 2

Surface Number

| | 1 | 2 |
|---|---|---|
| KA | −9.7039375E+00 | −1.8802024E+01 |
| A3 | −7.2172687E−06 | −2.5571731E−06 |
| A4 | 2.2421168E−05 | 2.6369726E−05 |
| A5 | −4.6121315E−07 | −6.0370822E−07 |
| A6 | −1.2841557E−08 | −2.7908322E−09 |
| A7 | 4.6503025E−10 | 2.1275964E−11 |
| A8 | 4.4713850E−12 | 1.1323479E−12 |
| A9 | −2.6839373E−13 | 3.6037911E−13 |
| A10 | 2.5801059E−15 | −6.5592567E−15 |

| | Surface Number | | |
|---|---|---|---|
| | 9 | 15 | 18 |
| KA | 4.9221961E+00 | −7.1622568E+01 | 5.9413409E+00 |
| A4 | −1.7356560E−07 | 4.0877797E−06 | 1.9629637E−05 |
| A6 | 4.8156280E−10 | −8.3503489E−09 | −1.3308548E−09 |
| A8 | −1.0416581E−12 | −1.6437430E−11 | −1.1253571E−10 |
| A10 | 7.2130689E−16 | −1.9271736E−13 | 1.5312659E−13 |

### Example 3

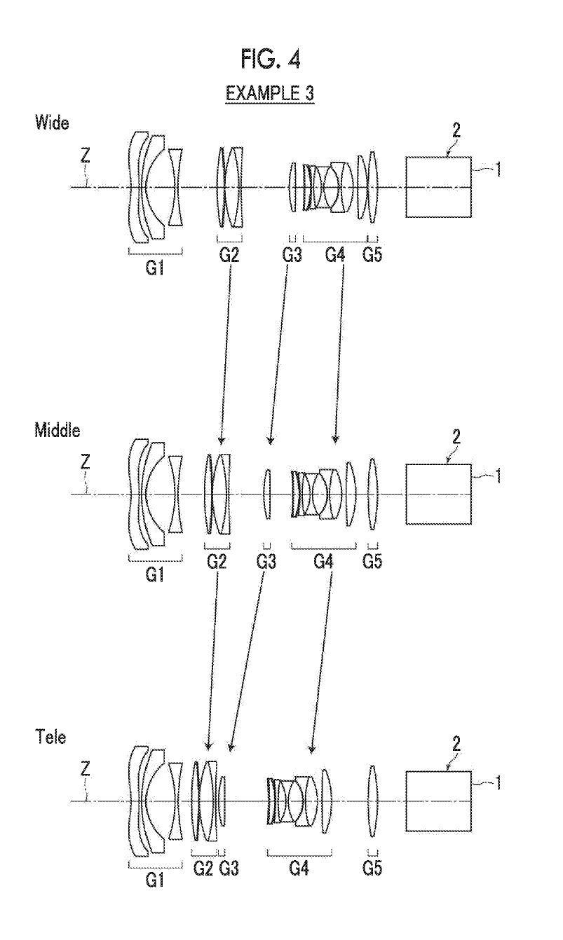

FIG. 4 is a sectional view of a projection zoom lens of Example 3. The projection zoom lens of Example 3 substantially has five lens groups including a first lens group G1 to a fifth lens group G5 in order from the magnification side. The sign of refractive power of each lens group, the lens groups moving during magnification change, the number of lenses in each lens group are the same as those in Example 1. Focusing when the projection distance is changed from infinity to a finite distance is performed by moving only the lens on the most reduction side of the first lens group G1 to the magnification side along the optical axis Z.

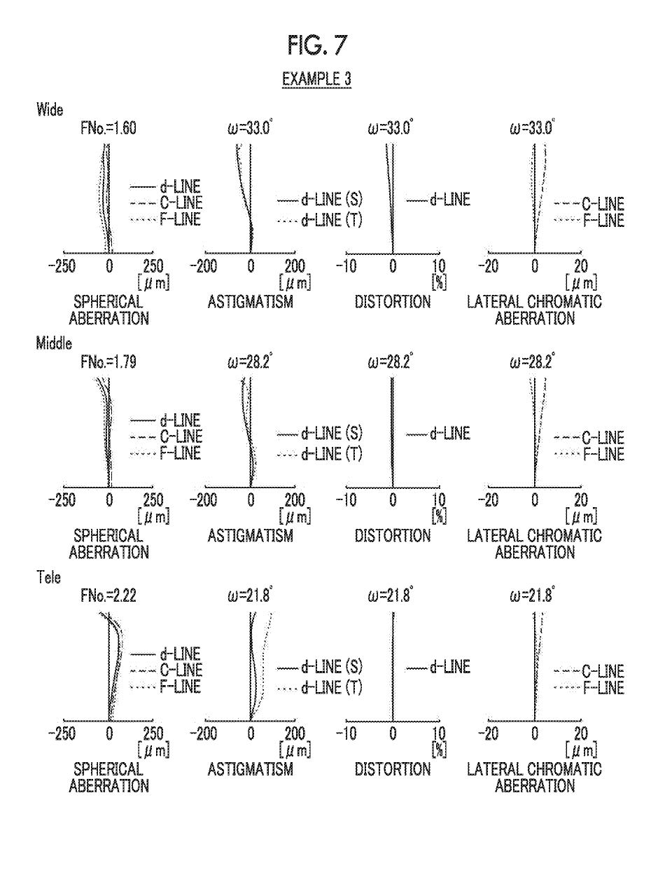

Table 7 shows basic lens data of the projection zoom lens of Example 3, Table 8 shows specs and values of variable surface distances, and Table 9 shows aspherical surface coefficients. An aspherical membrane is applied to each of the surface on the reduction side of the lens on the most magnification side of the second lens group G2 and the surfaces on the magnification side and the reduction side of the lens on the most magnification side of the fourth lens group G4, and these two lenses are compound aspherical lenses. FIG. 7 shows respective aberration diagrams of the projection zoom lens of Example 3. Data shown in Table 7, Table 8, and FIG. 7 is data in a case where the projection distance is 3.13 m.

TABLE 7
Example 3

| Si | Ri | Di | Ndj | νdj |
|---|---|---|---|---|
| *1 | −50.0002 | 4.9978 | 1.49100 | 57.58 |
| *2 | −82.1709 | 1.5009 | | |
| 3 | 83.7632 | 2.5009 | 1.61800 | 63.33 |
| 4 | 30.6148 | 17.5100 | | |
| 5 | −68.9890 | 1.8990 | 1.53775 | 74.70 |
| 6 | 109.3095 | DD[6] | | |
| 7 | 134.6176 | 4.3625 | 1.89286 | 20.36 |
| 8 | −214.7100 | 0.4003 | 1.52516 | 53.74 |
| *9 | −281.6454 | 0.0000 | | |
| 10 | 69.0069 | 8.5431 | 1.81600 | 46.62 |
| 11 | −94.8871 | 1.4999 | 1.89286 | 20.36 |
| 12 | 497.7044 | DD[12] | | |
| 13 | 58.5586 | 3.7893 | 1.59282 | 68.62 |
| 14 | −558.2731 | DD[14] | | |
| *15 | −153.1927 | 0.4005 | 1.52516 | 53.74 |
| 16 | −246.7315 | 3.4631 | 1.53775 | 74.70 |
| 17 | −43.4921 | 0.3993 | 1.52516 | 53.74 |
| *18 | −40.5648 | 0.0000 | | |
| 19 | −105.5772 | 1.5006 | 1.91650 | 31.60 |
| 20 | 69.5743 | 4.7547 | | |
| 21 | −25.6004 | 1.5002 | 1.51742 | 52.43 |
| 22 | 25.1473 | 8.9281 | 1.53775 | 74.70 |
| 23 | −19.3494 | 0.2522 | | |
| 24 | −18.9496 | 1.2999 | 1.74950 | 35.28 |
| 25 | 56.0077 | 7.3160 | 1.53775 | 74.70 |
| 26 | −33.6821 | 2.7669 | | |
| 27 | 334.7873 | 5.8850 | 1.85025 | 30.05 |
| 28 | −52.6750 | DD[28] | | |
| 29 | 127.8373 | 5.7074 | 1.59282 | 68.62 |
| 30 | −99.2348 | 17.2000 | | |
| 31 | ∞ | 39.6050 | 1.51633 | 64.14 |
| 32 | ∞ | | | |

TABLE 8
Example 3

| | Wide | Middle | Tele |
|---|---|---|---|
| Zr | 1.0 | 1.2 | 1.6 |
| f | 24.00 | 28.81 | 38.43 |
| FNo. | 1.60 | 1.79 | 2.22 |
| 2ω (°) | 66.0 | 56.4 | 43.6 |
| DD[6] | 23.80 | 16.20 | 8.22 |
| DD[12] | 29.29 | 21.30 | 1.76 |
| DD[14] | 5.32 | 13.91 | 26.67 |
| DD[28] | 0.50 | 7.49 | 22.26 |

TABLE 9
Example 3

Surface Number

| | 1 | 2 |
|---|---|---|
| KA | −1.1182773E+01 | −2.3267150E+01 |
| A3 | −2.2812389E−05 | −1.7977123E−05 |
| A4 | 2.2783537E−05 | 2.7018648E−05 |
| A5 | −4.5582745E−07 | −6.2712706E−07 |
| A6 | −1.3617896E−08 | −3.5471292E−09 |
| A7 | 4.7348239E−10 | 4.2026830E−11 |
| A8 | 4.7183022E−12 | 1.8848131E−12 |
| A9 | −2.7497689E−13 | 3.3962149E−13 |
| A10 | 2.4475013E−15 | −7.5060814E−15 |

| | Surface Number | | |
|---|---|---|---|
| | 9 | 15 | 18 |
| KA | 1.4947770E+01 | −2.6289520E+01 | 2.7843976E+00 |
| A4 | −3.1288533E−07 | 6.7138166E−07 | 1.6630110E−05 |
| A6 | 5.0577592E−10 | −1.4304778E−09 | −2.1266662E−09 |
| A8 | −1.0716863E−12 | 3.9625997E−12 | −7.5525381E−11 |
| A10 | 7.4146183E−16 | −2.4448753E−13 | −9.2202656E−14 |

Table 10 shows values corresponding to the conditional expressions (1) to (8) of the projection zoom lenses of Examples 1 to 3. The values shown in Table 10 are values for d-line.

TABLE 10

| Expression | | | | |
|---|---|---|---|---|
| Number | | Example 1 | Example 2 | Example 3 |
| (1) | ν1p − ν1n | 28.28 | 28.28 | 22.27 |
| (2) | ν2p − ν2n | 39.99 | 39.99 | 39.42 |
| (3) | fw/f1 | −0.812 | −0.823 | −0.813 |
| (4) | fw/f2 | 0.447 | 0.465 | 0.468 |
| (5) | f1/f2 | −0.551 | −0.565 | −0.576 |
| (6) | νmax | 74.70 | 74.70 | 74.70 |
| (7) | f4/RC41 | 8.076 | 8.235 | 9.223 |
| (8) | f4/RC42 | 2.468 | 3.237 | 4.141 |

As can be understood from data described above, the projection zoom lenses of Examples 1 to 3 have a wide angle such that the full angle of view at the wide-angle end is equal to or greater than 65°, have a small F-number such that the F-number at the wide-angle end is less than 1.65, and have satisfactorily corrected aberrations including chromatic aberration to realize high optical performance.

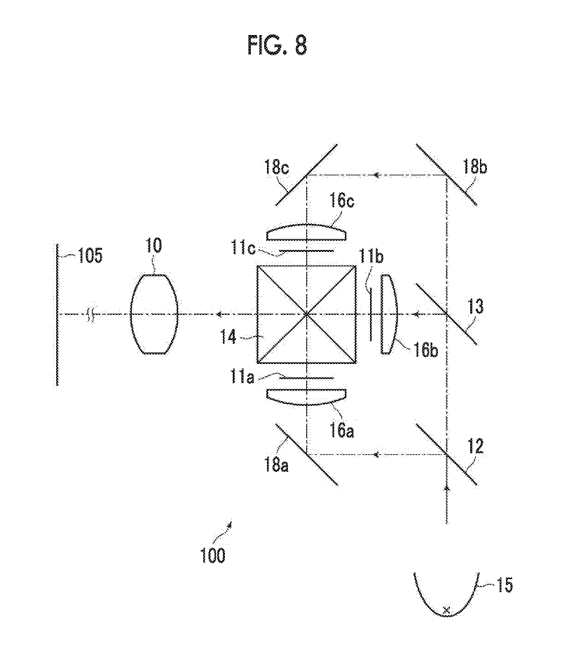

Next, a projection display apparatus according to an embodiment of the invention will be described. FIG. 8 is a schematic configuration diagram of a projection display apparatus according to an embodiment of the invention. A projection display apparatus 100 shown in FIG. 8 has the projection zoom lens 10 according to the embodiment of the invention, a light source 15, transmissive display elements 11a to 11c as light valves corresponding to respective color light components, dichroic mirrors 12 and 13 for color separation, a cross dichroic prism 14 for color combination, condenser lenses 16a to 16c and total reflection mirrors 18a to 18c for deflecting optical paths. FIG. 8 schematically shows the projection zoom lens 10. While an integrator is disposed between the light source 15 and the dichroic mirror 12, the integrator is not shown in FIG. 8.

After white light from the light source 15 is separated into three color light beams (G light, B light, and R light) by the dichroic mirrors 12 and 13, the three color light beams are respectively through the condenser lenses 16a to 16c, and then are incident on the transmissive display elements 11a to 11c corresponding to the respective color light beams to be optically modulated, are combined by the cross dichroic prism 14, and then incident on the projection zoom lens 10. The projection zoom lens 10 projects an optical image according to light optically modulated by the transmissive display elements 11a to 11c onto a screen 105.

Although the invention has been described in connection with the embodiment and the examples, the projection zoom lens of the invention is not limited to the foregoing examples and various changes and modifications may be made. For example, the radius of curvature, surface distance, refractive index, Abbe number, and aspherical surface coefficient of each lens can be changed as appropriate.

The projection display apparatus of the invention is not limited to that having the above-described configuration. For example, the light valve and the optical members for separating or combining a light beam are not limited to the above-described configurations, and various changes and modifications may be made.

### EXPLANATION OF REFERENCES

1: image display surface
2: optical member
4: axial light beam
5: light beam having maximum angle of view
5c: ray
5s: lower side outermost ray
5u: upper side outermost ray
10: projection zoom lens
11a to 11c: transmissive display element
12, 13: dichroic mirror
14: cross dichroic prism
15: light source
16a to 16c: condenser lens
18a to 18c: total reflection mirror
100: projection display apparatus
105: screen
CL1: first negative-positive cemented lens
CL2: second negative-positive cemented lens
G1: first lens group
G2: second lens group
G3: third lens group
G4: fourth lens group
G5: fifth lens group
L11 to L13, L21 to L23, L31, L41 to L47, L51: lens
Z: optical axis

What is claimed is:

1. A projection zoom lens comprising, in order from a magnification side:
a first lens group having negative refractive power;
a second lens group having positive refractive power;
a third lens group having positive refractive power;
a fourth lens group having positive refractive power; and
a fifth lens group having positive refractive power,
wherein, during magnification change, the first lens group and the fifth lens group are fixed and the second lens group, the third lens group, and the fourth lens group are moved while changing a distance from an adjacent lens group in an optical axis direction,
the fourth lens group includes two sets of negative-positive cemented lenses formed by cementing one negative lens and one positive lens in order from the magnification side, and
the following conditional expressions (1) and (2) are satisfied;
17<ν1p−ν1n<50 (1)
30<ν2p−ν2n<50 (2)
where
ν1p: an Abbe number for d-line of the positive lens in the negative-positive cemented lens on the most magnification side of the fourth lens group
ν1n: an Abbe number for d-line of the negative lens in the negative-positive cemented lens on the most magnification side of the fourth lens group
ν2p: an Abbe number for d-line of the positive lens in the negative-positive cemented lens on the most reduction side of the fourth lens group
ν2n: an Abbe number for d-line of the negative lens in the negative-positive cemented lens on the most reduction side of the fourth lens group.

2. The projection zoom lens according to claim 1,
wherein concave surfaces of the two sets of negative-positive cemented lenses of the fourth lens group are respectively directed toward the magnification side.

3. The projection zoom lens according to claim 1,
wherein the two sets of negative-positive cemented lenses of the fourth lens group are respectively formed by cementing a biconcave lens and a biconvex lens in order from the magnification side.

4. The projection zoom lens according to claim 1,
wherein the following conditional expression (3) is satisfied;
−1<fw/f1<−0.7 (3)
where
fw: a focal length of an entire system at a wide-angle end
f1: a focal length of the first lens group.

5. The projection zoom lens according to claim 2,
wherein the following conditional expression (3) is satisfied;
−1<fw/f1<−0.7 (3)
where
fw: a focal length of an entire system at a wide-angle end
f1: a focal length of the first lens group.

6. The projection zoom lens according to claim 1,
wherein the following conditional expression (4) is satisfied;
0.2<fw/f2<0.6 (4)
where
fw: a focal length of an entire system at a wide-angle end
f2: a focal length of the second lens group.

7. The projection zoom lens according to claim 1,
wherein the following conditional expression (5) is satisfied;
−0.65<f1/f2<−0.3 (5)
where
f1: a focal length of the first lens group
f2: a focal length of the second lens group.

8. The projection zoom lens according to claim 1,
wherein the following conditional expression (6) is satisfied;
νmax<78 (6)
where
νmax: a maximum value among Abbe numbers for d-line of lenses included in the entire system.

9. The projection zoom lens according to claim 1,
wherein the following conditional expression (7) is satisfied;
7<f4/RC41<10 (7)
where
f4: a focal length of the fourth lens group
RC41: a radius of curvature of a cemented surface of the negative-positive cemented lens on the most magnification side of the fourth lens group.

10. The projection zoom lens according to claim 1,
wherein the following conditional expression (8) is satisfied;
1.5<f4/RC42<5 (8)
where
f4: a focal length of the fourth lens group
RC42: a radius of curvature of a cemented surface of the negative-positive cemented lens on the most reduction side of the fourth lens group.

11. The projection zoom lens according to claim 1,
wherein the following conditional expression (1-1) is satisfied.
18<ν1p−ν1n<50 (1-1)

12. The projection zoom lens according to claim 1,
wherein the following conditional expression (1-2) is satisfied.
21<ν1p−ν1n<40 (1-2)

13. The projection zoom lens according to claim 1,
wherein the conditional expression (2-1) is satisfied.
35<ν2p−ν2n<45 (2-1)

14. The projection zoom lens according to claim 1,
wherein the following conditional expression (3-1) is satisfied;
−0.9<fw/f1<−0.8 (3-1)
where
fw: a focal length of an entire system at a wide-angle end
f1: a focal length of the first lens group.

15. The projection zoom lens according to claim 1,
wherein the following conditional expression (4-1) is satisfied;
0.35<fw/f2<0.55 (4-1)
where
fw: a focal length of an entire system at a wide-angle end
f2: a focal length of the second lens group.

16. The projection zoom lens according to claim 1,
wherein the following conditional expression (5-1) is satisfied.
−0.6<f1/f2<−0.35 (5-1)
where
f1: a focal length of the first lens group
f2: a focal length of the second lens group.

17. The projection zoom lens according to claim 1,
wherein the following conditional expression (6-1) is satisfied.
νmax<75 (6-1)
where
νmax: a maximum value among Abbe numbers for d-line of lenses included in the entire system.

18. The projection zoom lens according to claim 1,
wherein the following conditional expression (7-1) is satisfied;
7.5<f4/RC41<9.5 (7-1)
where
f4: a focal length of the fourth lens group
RC41: a radius of curvature of a cemented surface of the negative-positive cemented lens on the most magnification side of the fourth lens group.

19. The projection zoom lens according to claim 1,
wherein the following conditional expression (8-1) is satisfied;
2<f4/RC42<4.5 (8-1)
where
f4: a focal length of the fourth lens group
RC42: a radius of curvature of a cemented surface of the negative-positive cemented lens on the most reduction side of the fourth lens group.

20. A projection display apparatus comprising:
a light source;
a light valve on which light from the light source is incident, and
the projection zoom lens according to claim 1 as a projection zoom lens projecting an optical image according to light optically modulated by the light valve onto a screen.
